(19) United States
(12) Patent Application Publication
(10) Pub. No.: US 2018/0159281 A1
(43) Pub. Date: Jun. 7, 2018

(54) COMPOUND ELECTRONIC DEVICE

(71) Applicant: Apacer Technology Inc., New Taipei City (TW)

(72) Inventors: JIUNN-CHANG LEE, New Taipei City (TW); CHUN-CHIEH WU, New Taipei City (TW)

(21) Appl. No.: 15/415,209

(22) Filed: Jan. 25, 2017

(30) Foreign Application Priority Data
Dec. 2, 2016 (TW) 105139998

(51) Int. Cl. H01R 13/66; H01R 24/64; H01R 13/70

(52) U.S. Cl. CPC H01R 13/6691; H01R 2107/00; H01R 13/70; H01R 24/64

(57) ABSTRACT

A compound electronic device is provided herein, which is connected with a host to transmit data and includes a USB 3.0 male connector, a first electronic unit and a second electronic unit. The USB 3.0 male connector is electrically connected to the host, and includes a first differential signal wiring and a second differential signal wiring. The first electronic unit may transmit or receive the first signal through the first differential signal wiring, and the second electronic unit may transmit or receive the second signal through the second differential signal wiring. When the first signal is communicated between the USB 3.0 male connector and the host, the second signal is communicated between the USB 3.0 male connector and the host at the same time.

### CROSS-REFERENCE TO RELATED APPLICATION

This application claims priority from Taiwan Patent Application No. 105139998, filed on Dec. 2, 2016, at the Taiwan Intellectual Property Office, the content of which is hereby incorporated by reference in its entirety for all purposes.

### BACKGROUND OF THE INVENTION

### 1. Field of the Invention

The present disclosure is related to a compound electronic device. More specifically, the present disclosure is related to an electronic device capable of integrating different electronic components and communicating with a host via a USB 3.0 male connector.

### 2. Description of the Related Art

USB or Universal Serial Bus is an interface standard designed to solve the problems due to peripheral devices each having their own means of connection. A USB device is capable of supporting the Plug-and-Play functionality. When the driver for such device is installed in the operating system, the USB device can be installed or removed directly while the operating system is running, which makes the USB device more user-friendly.

USB 3.0 is the third major version of the USB standard, which was renamed as USB 3.1 Gen 1 by the USB Implementers' Forum (USB-IF). In addition to the Plug-and-Play functionality, USB 3.1 Gen 1 (USB 3.0) specification also supports USB 3.0 (SuperSpeed USB) and USB 2.0 (High Speed USB), the former has a transfer rate of up to 5 Gbit/s while the latter has a transfer rate of up to 480 Mbit/s.

Most electronic devices nowadays, for example, the USB flash drive, USB Bluetooth receiver or the USB Wi-Fi adapter, are capable of supporting USB3.0. The USB 3.0 male connectors of those electronic devices may be plugged into the USB port of a host computer, so as to enable the signal communication between those devices and the host computer. When both the electronic device and the host computer support USB 3.0 specification, both parties may communicate with the signal bandwidth of USB 3.0 specification. However, when one of the two parties only support USB 2.0 specification, following the communication on physical layer, both parties will automatically slow down the transfer rates thereof to that of the USB 2.0 and establish the communication.

Nowadays, the shifts in consumer habit have spurred portable electronic devices, such as the laptops and the tablets, towards smaller and lighter designs. Owing to this trend, the numbers of USB ports available on the portable electronic devices are being reduced. Thus, whenever a user is to add a peripheral having a USB male connector to a hosting portable electronic device, the user have to unplug the USB devices that are connected to the hosting portable electronic device before he or she can insert the peripheral. This method of repeated removals and additions of peripherals tend to cause great inconvenience to the users.

### SUMMARY OF THE INVENTION

To this end, the present disclosure provides a compound electronic device, which may be connected with a host to transmit data and may include a USB 3.0 male connector, a first electronic unit and a second electronic unit. The USB 3.0 male connector may be electrically connected to the host, and may include a first differential signal wiring and a second differential signal wiring. The first electronic unit may transmit or receive the first signal through the first differential signal wiring, and the second electronic unit may transmit or receive the second signal through the second differential signal wiring. When the first signal is communicated between the USB 3.0 male connector and the host, the second signal may be communicated between the USB 3.0 male connector and the host at the same time.

To this end, the present disclosure further provides a compound electronic device, which may be connected with a host to transmit data and may include a USB 3.0 male connector, a first electronic unit, a second electronic unit, and a signal switch. The USB 3.0 male connector may be electrically connected to the host. The USB 3.0 male connector may include a first differential signal wiring and a second differential signal wiring. The signal switch may be electrically connected to the second differential signal wiring, the first electronic unit, and the second electronic unit. The signal switch may switch the signal transmission between the second differential signal wiring and the first electronic unit and the signal transmission between the second differential signal wiring and the second electronic unit. In the event of the first electronic unit failing to establish connection with the host via the first differential signal wiring, the first electronic unit may then control the signal switch to establish the connection between the second differential signal wiring and the first electronic unit, such that data transmission between the first electronic unit and the host via the second differential signal wiring can be performed.

### BRIEF DESCRIPTION OF THE DRAWINGS

FIG. 1 is a block diagram of the compound electronic device according to the first embodiment of the present disclosure.

FIG. 2 is a schematic diagram of the compound electronic device according to the second embodiment of the present disclosure.

FIG. 3 is a schematic diagram of the compound electronic device according to the third embodiment of the present disclosure.

FIG. 4 is the first block diagram of the compound electronic device according to the fourth embodiment of the present disclosure.

FIG. 5 is the second block diagram of the compound electronic device according to the fourth embodiment of the present disclosure.

### DESCRIPTION OF THE PREFERRED EMBODIMENTS

Various aspects such as the technical features, advantages or content of the present disclosure will be set forth in detail in the form of preferred embodiments hereinafter, and the description will be made along with reference to the attached drawings, which are solely illustrative and serve to provide better understanding of the present disclosure only, the scale and/or proportion of any portion of the drawing do not represent the actual configuration of the disclosure, hence the scale, proportion or shape in the drawings should not be misconstrued as limiting the scope of the disclosure.

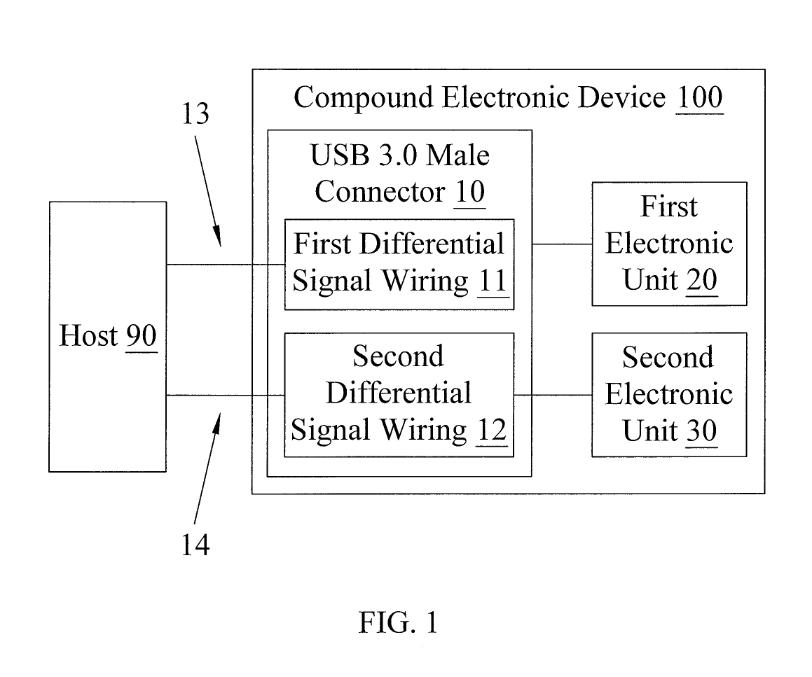

FIG. 1 is a block diagram of the compound electronic device according to the first embodiment of the present disclosure. As shown in the drawing, the compound electronic device 100 may be connected with a host 90 to transmit signal. The host 90 may be a laptop, a tablet, or a desktop computer that includes a USB 3.0 port (i.e. a female connector). The compound electronic device 100 may include a USB 3.0 male connector 10, a first electronic unit 20, and a second electronic unit 30, which will be further described hereinafter.

The USB 3.0 male connector 10 may be electrically connected to the USB 3.0 port of the host 90. The USB 3.0 male connector 10 may include a first differential signal wiring 11 and a second differential signal wiring 12. Furthermore, the first differential signal wiring 11 may include two groups of differential pairs, namely the StdA_SSRX− and StdA_SSRX+ differential pair and the StdA_SSTX− and StdA_SSTX+ differential pair. The second differential signal wiring 12 may include a group of differential pair, which is the D+ and D− differential pair.

The first electronic unit 20 may transmit or receive the first signal 13 through the first differential signal wiring 11, and the second electronic unit 30 may transmit or receive the second signal 14 through the second differential signal wiring 12. The first signal 13 may be a USB 3.0 signal, and the second signal 14 may be a USB 2.0 signal. It is worth noting that when the first signal 13 is communicated between the USB 3.0 male connector 10 and the host 90, the second signal 14 may also be communicated between the USB 3.0 male connector 10 and the host 90 simultaneously.

From the description above, it can be appreciated that the first and second electronic units 20 and 30 of the compound electronic device 100 may respectively perform differential signal transmissions via the pins for USB 3.0 and USB 2.0. For instance, Table 1 displays the pinouts for the connectors in USB 3.0 Standard A and USB 3.0 Standard B, respectively. For the case in which the compound electronic device 100 of the present disclosure has the connector in USB 3.0 Standard A, Pin 1 thereof is then configured to receive the power from the host 90, and Pins 2 and 3 may be for the second differential signal wiring 12 of the present disclosure, whereas Pins 5, 6, 8, and 9 may be for the first differential signal wiring 11. Pins 4 and 7 may be ground pins. The first electronic unit 20 and the second electronic unit 30 may simultaneously communicate with the host 90 via the first differential signal wiring 11 and the second differential signal wiring 12, respectively. The aforementioned descriptions are exemplary and non-limiting. The compound electronic device 100 of the present disclosure may also be used for USB3.0-B connector, USB 3.0 Powered-B connector, or any other connectors capable of supporting both the USB 3.0 and USB 2.0 communication protocols.

TABLE 1
Pinout Configurations for USB 3.0 Connector Standard-A and
Standard-B Connector

| | | Signal (Standard-A | Signal (Standard-B |
|---|---|---|---|
| Pin No. | Color | Connector) | Connector |
| 1 | Red | VBUS | |
| 2 | White | D− | |
| 3 | Green | D+ | |
| 4 | Black | GND | |
| 5 | Blue | StdA_SSRX− | StdB_SSTX− |
| 6 | Yellow | StdA_SSRX+ | StdB_SSTX+ |
| 7 | Shield | GND_DRAIN | |
| 8 | Purple | StdA_SSTX− | StdB_SSRX− |
| 9 | Orange | StdA_SSTX+ | StdB_SSRX+ |

In a preferred embodiment, the first electronic unit 20 may include a USB Bluetooth receiver, a USB Wi-Fi adapter, a USB flash drive, a portable hard drive, or a USB power bank.

In a preferred embodiment, the second electronic unit 30 may include a USB Bluetooth receiver, a USB Wi-Fi adapter, a USB flash drive, a portable hard drive, or a USB power bank.

In a best embodiment, the first and second electronic units 20 and 30 may be different combinations of electronic units depending on the transfer speeds and the user requirements. For instance, the first electronic unit 20 may be a USB flash drive, and the second electronic unit 30 may be a Bluetooth receiver. Since signal transmission between the second electronic unit 30 and the host 90 may be carried out in USB 2.0 bandwidth, the peripheral that requires lower transfer speed, e.g. the Bluetooth receiver for wireless mouse or keyboard, may be selected as the second electronic unit 30 in this combination. On the contrary, the signal transmission between the first electronic unit 20 and the host 90 may be carried out in the USB 3.0 bandwidth, so the storage device that requires higher transfer speed, e.g. the flash drive, portable hard drive, etc., may be selected as the first electronic unit 20 in this combination. The aforementioned combination is merely an example, and the present embodiment is not limited thereto. The user may implement different combinations or adjustments according to the practical requirement.

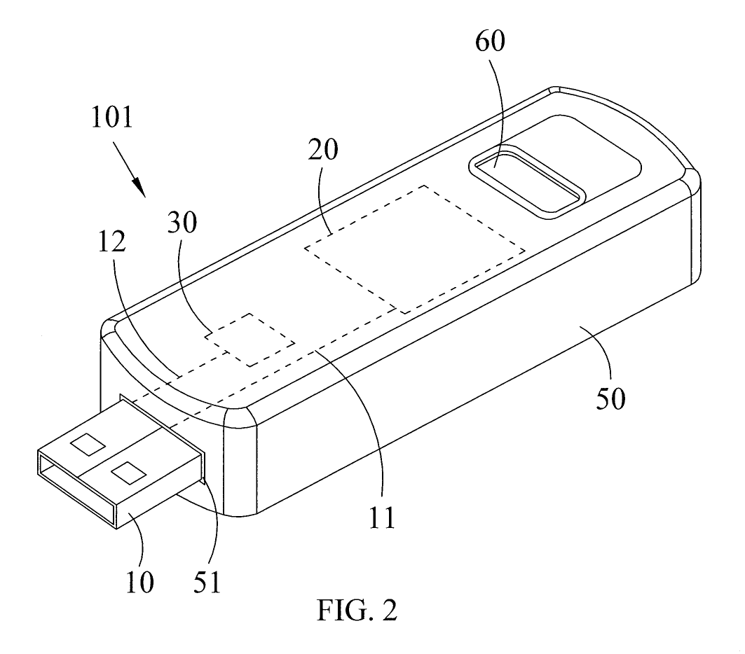

Descriptions hereinafter refers to FIG. 2, which is a schematic diagram of the compound electronic device according to the second embodiment of the present disclosure. Reference should also be made to FIG. 1. In the present embodiment, the compound electronic device 101 may further include a housing 50 in addition to the USB 3.0 male connector 10, first electronic unit 20, and second electronic unit 30. The housing 50 may be hollow and may be disposed with an opening 51. The first and second electronic units 20 and 30 may be individually fixed in the housing 50, and the USB 3.0 male connector 10 may be disposed at the opening 51 for connection with the USB 3.0 port of the host 90.

More specifically, in the present embodiment, the first electronic unit 20 may be, for example, a flash drive. The flash drive may include a flash memory and a microcontroller, which are disposed on a printed circuit board (PCB). The PCB may be fixed in the housing 50, and the first electronic unit 20 may transmit or receive USB 3.0 signals to or from the host 90 through the first differential signal wiring 11. On the other hand, the second electronic unit 30 may include a USB Wi-Fi adapter, and the second electronic unit 30 may transmit or receive USB 2.0 signals to or from the host 90 through the second differential signal wiring 12. In other words, the compound electronic device 101 is capable of providing data storage and wireless Internet service by connecting just one USB 3.0 male connector to the USB 3.0 port of the host 90.

What is noteworthy is that the second electronic unit 30 may be an electronic device that supports the bandwidths for both USB 2.0 and USB 3.0. The support for USB 2.0 bandwidth means that the second electronic unit 30 may be disposed with the male connector for USB 2.0, and the support for USB 3.0 bandwidth means that the second electronic unit 30 may be disposed with the male connector for USB 3.0. When the second electronic unit 30 is an electronic device with the bandwidth for USB 3.0, due to the fact that the first differential signal wiring 11 is already occupied by the first electronic unit 20, hence following the detection process in physical layer, the second electronic unit 30 may automatically reduce the bandwidth thereof to the bandwidth for USB 2.0. The second electronic unit 30 may then communicate with the host 90 via the second differential signal wiring 12 in USB 2.0 signals.

In a preferred embodiment, the compound electronic device 101 may further include a jumper 60. One end of the jumper 60 may be disposed in the vicinity of the housing 50 so that the user can toggle it, and the other end of the jumper 60 may be electrically connected to the first and second electronic units 20 and 30, so as to control the ON/OFF of the first signal 13 and the second signal 14. For instance, in one embodiment, preset status for the first electronic unit 20 and the second electronic unit 30 may both be ON. Whenever the user like to turn off the function of the second electronic unit 30, the jumper 60 may be manually toggled to achieve such purpose. The jumper 60 may control the ON/OFF of the first signal 13 and the second signal 14 by means of shorting, and the implementation thereof is well-known in the relevant art, so redundant details will be omitted.

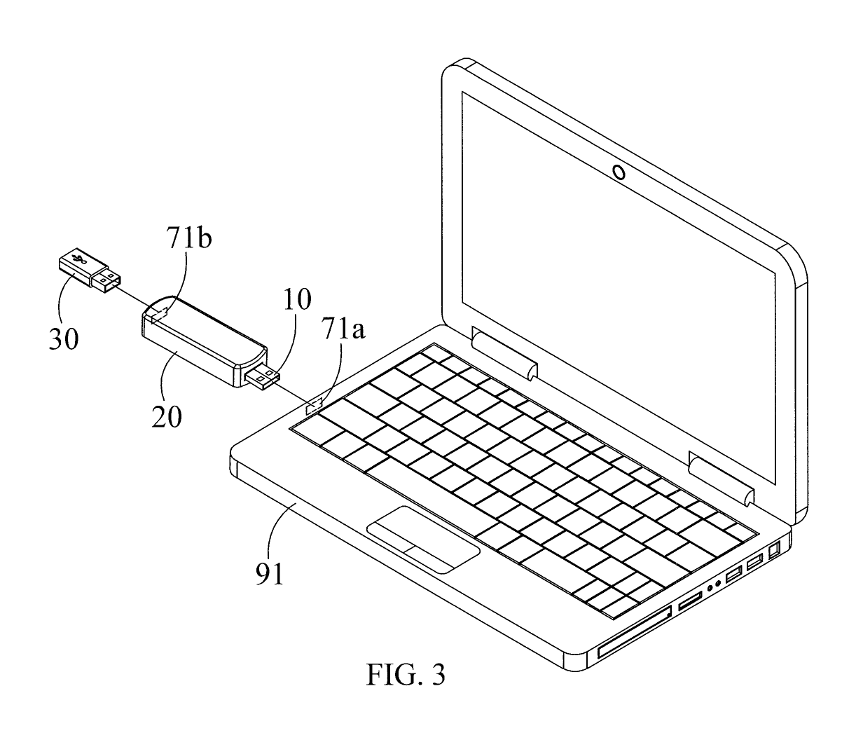

Descriptions hereinafter refers to FIG. 3, which is a schematic diagram of the compound electronic device according to the third embodiment of the present disclosure. Reference should also be made to FIG. 1. The compound electronic device 100 may include the USB 3.0 male connector 10, first electronic unit 20, second electronic unit 30, and a housing 50. The housing 50 may be hollow and may be disposed with an opening 51 along with a USB port 71b. The USB port 71b may be disposed in the vicinity of the housing 50, and the second electronic unit 30 may be disposed with a USB 2.0 male connector.

In the present embodiment, the first electronic unit 20 may be fixed in the housing 50, and the USB 3.0 male connector 10 may be disposed at the opening 51 and may be plugged into the USB port 71a of a laptop 91. As in the first embodiment, the USB 3.0 male connector 10 may include the first differential signal wiring 11 and the second differential signal wiring 12; the former may be electrically connected to the first electronic unit 20 while the latter may be electrically connected to the USB port 71b. The second electronic unit 30 may be plugged into the USB port 71b via the USB 2.0 male connector thereof, such that the second signal 14 may be transmitted between the second electronic unit 30 and the laptop 91. It is worth noting that the USB port 71a may support the USB 3.0 specification, and the USB port 71b may support the USB 2.0 specification.

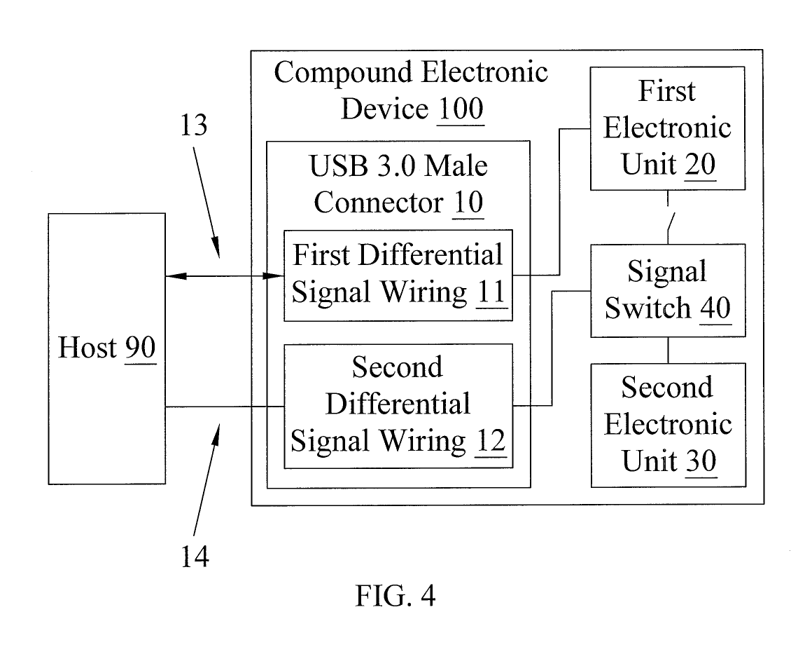

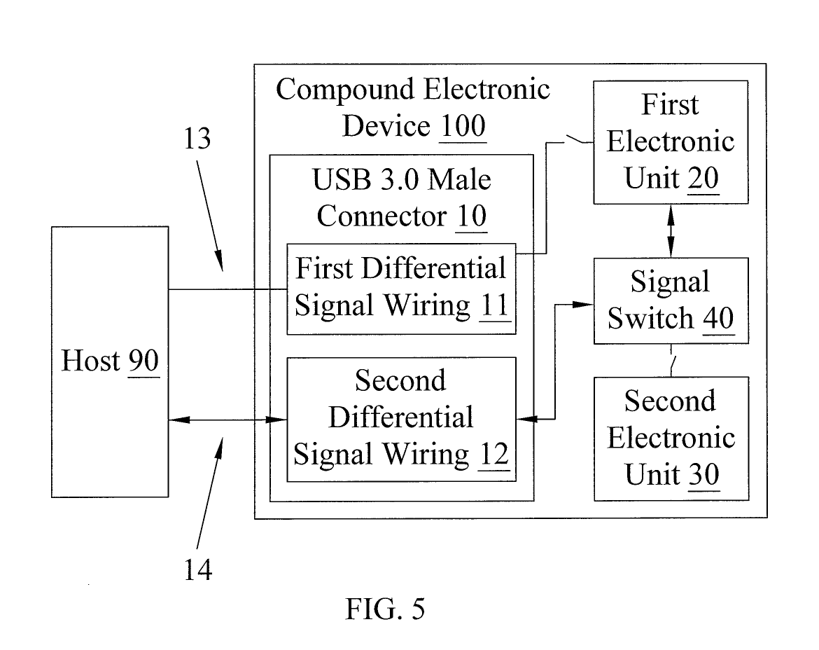

Descriptions hereinafter refers to FIGS. 4 and 5, which are the first and second block diagrams of the compound electronic device according to the fourth embodiment of the present disclosure. As shown in the drawings, the compound electronic device 100 of the present disclosure may be connected to a host 90 for signal transmission. The compound electronic device 100 may include a USB 3.0 male connector 10, a first electronic unit 20, a second electronic unit 30, and a signal switch 40.

In the present embodiment, the USB 3.0 male connector 10 may be electrically connected to the host 90. The USB 3.0 male connector 10 may include a first differential signal wiring 11 and a second differential signal wiring 12. The first differential signal wiring 11 may include the StdA_SSTX− and StdA_SSTX+ differential pair and the StdA_SSTX− and StdA_SSTX+ differential pair. The second differential signal wiring 12 may include the D+ and D− differential pair.

The signal switch 40 may be electrically connected to the second differential signal wiring 12, the first electronic unit 20, and the second electronic unit 30. The signal switch may switch the signal transmission between the second differential signal wiring 12 and the first electronic unit 20 and the signal transmission between the second differential signal wiring 12 and the second electronic unit 30.

Furthermore, in a preferred embodiment, after the USB 3.0 male connector 10 is plugged into the USB 3.0 port of the host 90, the first electronic unit 20 may establish connection with the host 90 via the first differential signal wiring 11. Subsequently, the signal switch 40 may establish the connection between the second differential signal wiring 12 and the second electronic unit 30, such that the second electronic unit 30 may communicate with the host 90 via the second differential signal wiring 12. In other words, both the first and second electronic units 20 and 30 may perform signal communication with the host 90 at the same time, in particular, the first electronic unit 20 and the second electronic unit 30 may simultaneously communicate with the host 90 via the USB 3.0 and USB 2.0 signals, respectively, as shown in FIG. 4.

On the other hand, in another preferred embodiment, in the case of the USB 3.0 male connector 10 being plugged into the USB 2.0 port of the host 90, the first electronic unit 20 will fail to establish connection with the host 90 via the first differential signal wiring 11. Under this circumstance, the first electronic unit 20 may control the signal switch 40 to establish the connection between the second differential signal wiring 12 and the first electronic unit 20, such that signal may be transmitted between the first electronic unit 20 and the host 90 through the second differential signal wiring 12. In the meantime, the second electronic unit 30 may stop signal transmissions with the host 90, as shown in FIG. 5. In other words, the first electronic unit 20 under this circumstance may automatically slow down the transfer rate thereof to the transfer rate of USB 2.0, and the first electronic unit 20 may be given priority to communicate with the host 90; in the meantime, the function of the second electronic unit 30 may be automatically shut down because of failure in signal transmission.

In a preferred embodiment, the first electronic unit 20 may include a USB Bluetooth receiver, a USB Wi-Fi adapter, a USB flash drive, a portable hard drive, or a USB power bank. The second electronic unit 30 may include a USB Bluetooth receiver, a USB Wi-Fi adapter, a USB flash drive, a portable hard drive, or a USB power bank.

In conclusion, with the compound electronic device of the present disclosure, two electronic devices may execute their respective functions through one existing USB 3.0 male connector. Since the numbers of USB ports on the computers nowadays are decreasing, the compound electronic device of the present disclosure may allow the addition of computer peripherals without the need of additional USB ports, which saves cost and improves the convenience for users.

While the present disclosure is described with some preferred embodiments, it is understood that many changes and modifications in the described embodiments can be carried out without departing from the scope and the spirit of the inventive concept that is intended to be limited only by the appended claims.

What is claimed is:

1. A compound electronic device connected with a host to transmit data, the compound electronic device comprising:
a USB 3.0 male connector for electrically connecting to the host, the USB 3.0 male connector comprising a first differential signal wiring and a second differential signal wiring;
a first electronic unit transmitting or receiving a first signal through the first differential signal wiring; and
a second electronic unit transmitting or receiving a second signal through the second differential signal wiring;
wherein when the first signal is communicated between the USB 3.0 male connector and the host, the second signal is communicated between the USB 3.0 male connector and the host simultaneously.

2. The compound electronic device of claim 1, wherein the first differential signal wiring comprises an StdA_SSRX− and StdA_SSRX+ differential pair, as well as an StdA_SSTX− and StdA_SSTX+ differential pair.

3. The compound electronic device of claim 1, wherein the first signal comprises a USB3.0 signal.

4. The compound electronic device of claim 1, wherein the second differential signal wiring comprises a D+ and D− differential pair.

5. The compound electronic device of claim 1, wherein the second signal comprises a USB2.0 signal.

6. The compound electronic device of claim 1, wherein the first electronic unit comprises a USB Bluetooth receiver, a USB Wi-Fi adapter, a USB flash drive, a USB portable hard drive, or a USB power bank.

7. The compound electronic device of claim 1, wherein the second electronic unit comprises a USB Bluetooth receiver, a USB Wi-Fi adapter, a USB flash drive, a USB portable hard drive, or a USB power bank.

8. The compound electronic device of claim 1, further comprising a housing, wherein the housing is hollow and is disposed with an opening, the first electronic unit is fixed in the housing, and the USB 3.0 male connector is disposed at the opening for connection with the host.

9. The compound electronic device of claim 8, further comprising a jumper connected to the first and second electronic units, the jumper controlling the transmissions of the first signal and the second signal.

10. The compound electronic device of claim 8, wherein the housing is disposed with a USB port electrically connected to the second differential signal wiring, and the second electronic unit receives or transmits the second signal through the USB port.

11. A compound electronic device connected with a host to transmit data, the compound electronic device comprising:
a USB 3.0 male connector for electrically connecting to the host, the USB 3.0 male connector comprising a first differential signal wiring and a second differential signal wiring;
a first electronic unit;
a second electronic unit; and
a signal switch electrically connected to the second differential signal wiring, the first electronic unit, and the second electronic unit, the signal switch switching signal transmission between the second differential signal wiring and the first electronic unit and signal transmission between the second differential signal wiring and the second electronic unit;
wherein in the event of the first electronic unit failing to establish connection with the host via the first differential signal wiring, the first electronic unit controls the signal switch to establish connection between the second differential signal wiring and the first electronic unit, such that data transmission between the first electronic unit and the host via the second differential signal wiring is performed.

12. The compound electronic device of claim 11, wherein in the event of the first electronic unit establishing connection with the host via the first differential signal wiring, the signal switch establishes connection between the second differential signal wiring and the second electronic unit, such that data transmission between the second electronic unit and the host via the second differential signal wiring is performed.

13. The compound electronic device of claim 11, wherein the first differential signal wiring comprises an StdA_SSRX− and StdA_SSRX+ differential pair, as well as an StdA_SSTX− and StdA_SSTX+ differential pair.

14. The compound electronic device of claim 11, wherein the second differential signal wiring comprises a D+ and D− differential pair.

15. The compound electronic device of claim 11, wherein the first electronic unit comprises a USB Bluetooth receiver, a USB Wi-Fi adapter, a USB flash drive, a USB portable hard drive, or a USB power bank.

16. The compound electronic device of claim 11, wherein the second electronic unit comprises a USB Bluetooth receiver, a USB Wi-Fi adapter, a USB flash drive, a USB portable hard drive, or a USB power bank.
